(19) United States
(12) Patent Application Publication
(10) Pub. No.: US 2022/0230790 A1
(43) Pub. Date: Jul. 21, 2022

(54) CONTROL ELEMENT

(71) Applicant: ZF Friedrichshafen AG, Friedrichshafen (DE)

(72) Inventors: Erwin BIEGGER, Wangen im Allgäu (DE); Fabian SCHRADER, Friedrichshafen (DE); Michael PANTKE, Friedrichshafen (DE); Georg TENCKHOFF, Friedrichshafen (DE); Joachim BILLER, Lorch (DE)

(73) Assignee: ZF Friedrichshafen AG, Friedrichshafen (DE)

(21) Appl. No.: 17/608,394

(22) PCT Filed: Mar. 5, 2020
(86) PCT No.: PCT/EP2020/055761

§ 371 Date: Nov. 2, 2021

(30) Foreign Application Priority Data
May 3, 2019 (DE) 10 2019 206 405.1

(51) Int. Cl. H01F 1/44; G06F 3/01

(52) U.S. Cl. CPC H01F 1/447; G06F 3/016

(57) ABSTRACT

A control element comprises a magnetorheological elastomer or a magnetorheological fluid and at least one drive assembly for generating a variable magnetic field. A variable feel for the user can be generated by means of the drive assembly.

The invention relates to a control element that is preferably used in a vehicle, in particular a motor vehicle, rail vehicle, aircraft, or boat.

There are numerous control elements in vehicles that can easily distract a driver when operated. This can result in undesired reactions or even the risk of an accident.

Based on this, the fundamental object of the invention is to create a control element that distracts the diver as little as possible.

This object is achieved by a control element comprising a magnetorheological material, which has at least one drive assembly for generating a variable magnetic field.

This object is achieved entirely in this manner.

According to the invention, a change in a magnetic field can generate a change in the feel of the control element. This can be achieved in particular by a change in the shape of the control element and/or by a change in the stiffness of the control element. In this manner, communication with a user of the control element can be established, without the user having to look at the control element itself, and thus becoming distracted.

The magnetorheological material can be a magnetorheological elastomer or a magnetorheological fluid. A magnetorheological elastomer contains magnetorheological material dispersed in the elastomer. This is usually carbonyl iron powder, which is homogenously dispersed in the elastomer. For special applications, the magnetorheological material can also be dispersed with a specific texture.

Under the effects of a magnetic field, the magnetorheological elastomer aligns itself with the direction of the field. If the magnetorheological elastomer forms the core of a coil, for example, the magnetic field results in a lengthening in the longitudinal direction of the coil, or a cross section reduction in the transverse direction of the coil. The shape therefore changes in a manner that the user feels.

If the magnetorheological material is a magnetorheological fluid, this material is then sealed into a hollow chamber in an elastomer. A change in the magnetic field only results in a change in the viscosity, and therefore the stiffness, of the switching element, but not in a change in shape. This change in stiffness can also be felt by a user.

According to another embodiment of the invention, the drive assembly is designed to generate a vibration in the control element, in particular with different frequencies that can be distinguished by the user, or for different lengths of time and/or intermittently.

The user can be notified in this manner by a vibration indicating that an input has been entered correctly.

By way of example, a user can be notified by a vibration if an input has been entered correctly, e.g. a telephone number has been input. Different frequencies can also indicate to the user whether an input is for increasing a specific value or decreasing a specific value. Different frequencies can also be used to provide a user with specific feedback, or specific requests for an input. In a similar manner, different lengths of time, and/or intermittent outputs, of a frequency can be used to communicate with a user.

According to another embodiment of the invention, the drive assembly is configured to allow at least a part of the control element to protrude from or retract into a surface when it is activated.

In this manner, the control element can then retract into a surface when it is not needed, for example, and only protrude when an input is needed.

The control element is preferably in the form of a push key or button.

According to another embodiment of the invention, the control element comprises numerous individual control elements, each of which has its own drive assembly.

In this manner, an entire input panel can be obtained, e.g. for inputting a telephone number.

According to another embodiment of the invention, the operating element contains a magnetorheological elastomer that is coupled to a coil for generating a variable magnetic field, wherein the coil is coupled to an electrical switching device, and is coupled at least at one end to an element of the drive assembly that can be moved manually via a connector, wherein the switching device contains means for monitoring the magnetic field and/or capacitance between the two connectors in order to trigger a switching procedure when the element that can be moved manually is activated.

The control element is combined with an electric switching device in this manner. The control element is thus simple and compact, forming a switching device as well as a variable feel for communicating with a user.

A control element according to the invention can preferably be produced with 3D printing.

Almost any shape can be obtained with 3D printing, such that the control element can be readily adapted to different applications and requirements.

As specified above, a control element according to the invention can preferably be used to communicate with a user, which is obtained by a change in the feel of the control element that can be felt by a user. A vibration can be used for this, to give a user feedback regarding the activation of the control element, or to request an input from a user.

As specified above, a control element according to the invention can preferably be used in a vehicle, in particular a motor vehicle, rail vehicle, aircraft, or boat.

It should be understood that the features of the invention specified above and explained below can be used, not only in the respective combinations that are given herein, but also in other combinations or in and of themselves, without abandoning the scope of the invention.

Further features and advantages of the invention can be derived from the following description of preferred exemplary embodiments in reference to the drawings. Therein:

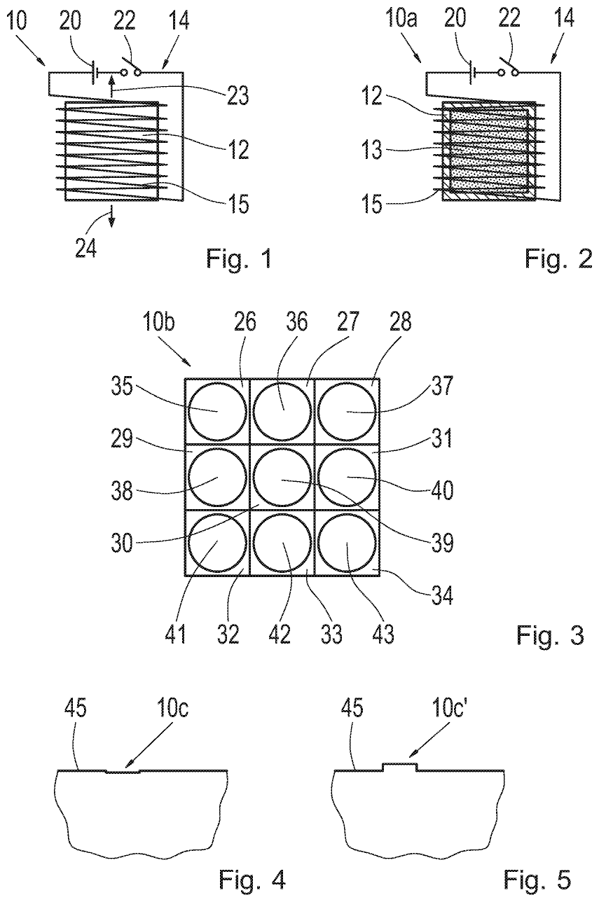

FIG. 1 shows a schematic illustration of a control element according to the invention, which has a magnetorheological elastomer;

FIG. 2 shows a schematic illustration of a second embodiment of a control element according to the invention, which has a magnetorheological fluid;

FIG. 3 shows a schematic illustration of a control element according to the invention, composed of numerous magnetorheological individual elements;

FIG. 4 shows a partial view of a control element according to the invention, recessed into a surface in the inactive state;

FIG. 5 shows a view of the control element according to FIG. 4 in the activated state, protruding in part from the surface;

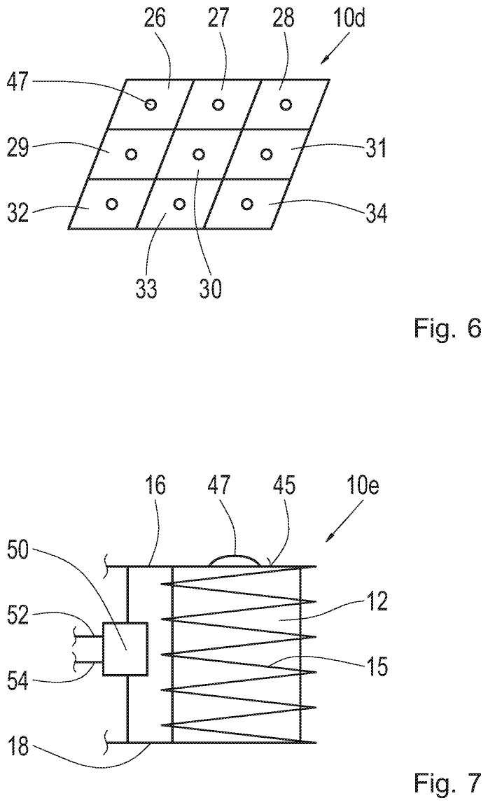

FIG. 6 shows a schematic illustration of a control element composed of nine individual elements, wherein each individual element also contains a switch element;

FIG. 7 shows an enlarged depiction of another embodiment of a control element according to the invention, which can be used as an electrical switching element, and also contains a magnetorheological elastomer for communicating with the user by changing the feel thereof.

A schematic illustration of a control element according to the invention is indicated as a whole with the numeral 10 in FIG. 1. This is a control element 10 that has a magnetorheological elastomer 12 in the form of a block surrounded by a coil 15.

The magnetorheological elastomer 12 contains magnetizable particles that are dispersed in the elastomer matrix. This is usually carbonyl iron powder that is homogenously dispersed in the elastomer matrix. A texture can also be provided for special applications.

When an external magnetic field is applied, the magnetizable particles are reversibly magnetized in the magnetic field. This results in a change in shape, which can result in a change in length, i.e. a lengthening, as indicated by the arrows 23 and 24, as well as a corresponding reduction in the cross section. The stiffness of the magnetorheological elastomer 12 can also change. A drive assembly 14 comprises a coil 15, a power source, and a switch 22.

The power source 20 and the switch 22 can preferably be controlled electronically. The coil can be an annular coil in a cylindrical, elongated shape, within which the magnetorheological elastomer 12 is enclosed. It should be understood that a variety of other coils can also be used.

It should be understood that the magnetorheological elastomer 12 does not have to be in the shape of a block, but instead can take nearly any arbitrary shape, which can be readily obtained with 3D printing. By way of example, it can be a hollow structure, or a structured hollow structure containing identical or different individual elements.

FIG. 2 shows a variation on the embodiment shown in FIG. 1, and is indicated as a whole with the numeral 10a. The same reference symbols are used for the same elements in the other figures as well.

Instead of a magnetorheological elastomer, this embodiment contains a magnetorheological fluid 13, which is sealed into a hollow chamber in an elastomer. This construction also corresponds to the assembly in FIG. 1.

Under the effect of a magnetic field, only the stiffness of the control element 10a is changed, while its shape remains the same.

The control element 10 or 10a in FIG. 1 and FIG. 2 respectively, can be part of a switching element with which an electric switch is actuated. The control element 10 or 10a can therefore be part of a mechanical tappet, with which an electric switch is actuated. The drive assembly 14 is used to generate a variable feel through a change in the shape and/or stiffness of the elastomer 12, which can be felt by a user.

As a result, a user can be given feedback as to whether the control element has been actuated correctly to execute a specific input. Furthermore, the elastomer can be caused to vibrate, wherein different frequencies, lengths of time, and/or an intermittent output can be used to exchange certain information with the user.

The control element can also be composed of numerous individual elements, as is shown schematically in FIGS. 3 and 6.

The control element 10b in FIG. 3 is composed, by way of example, of nine individual control elements 26, 27, 28, 29, 30, 31,32, 33, and 34, arranged in the manner of a chess board. Each individual control element 26 to 34 has its own drive assembly 35, 36, 37, 38, 39, 40, 41, 42, 43 that has a coil that can be activated individually (connectors not shown).

In this manner, larger input panels can be obtained, e.g. like those for a telephone keypad. A switching procedure can be obtained with each individual control element 26 to 34, and communication with a user can take place in that a change in the shape or stiffness, and thus in the feel, is obtained that can be felt by a user.

Another embodiment of a control element according to the invention is shown in FIGS. 4 and 5, indicated as a whole with the numeral 10c. This control element 10c is recessed in a surface 45, and can move therein. When it is activated, as indicated by way of example in FIG. 5, part of the control elements 10c′ protrude from the surface 45.

FIG. 6 shows another control element, indicated as a whole with the numeral 10d, which is also composed of nine individual control elements 26 to 34 arranged in the manner of a chess board.

Each of the individual control elements 26 to 34 also contains a switch element 47, which triggers an electric switching procedure when activated manually. Depending on the predefined structure thereof, there is a specific pressure point characteristic in the inactive state, through which a switching procedure can be triggered when actuated manually (fail-safe operation). In the activated state, this switching characteristic can be altered, and communication with the user can be established as described above.

Another control element is shown by way of example in FIG. 7, indicated as a whole with the numeral 10e. This is a control element with which an electrical switching element 50 is obtained, and which is combined with a magnetorheological elastomer 12 to generate a variable feel.

The coil 15 is connected at a first end, via a flat connector 16, to the magnetorheological elastomer 12, which contains a protruding switch element 47.

The coil 15 is connected at its other end to the drive assembly 14 via a connector 18.

A switching device 50 is interconnected between the two connectors 16, 18. The switching device 50 contains an electronic monitor that registers a change in the magnetic field and/or the capacitance between the two connectors 16, 18 when the switch element 47 is depressed manually. This triggers a switching procedure that results in a switching between the two connectors 52, 54.

### REFERENCE SYMBOLS

10, 10a, 10b, 10c, 10d, 10e control element
12 elastomer
13 magnetorheological fluid
14 drive assembly
15 coil
16 first connector
18 second connector
20 power source
22 switch
23 arrow
24 arrow
26 individual control element
27 individual control element
28 individual control element
29 individual control element
30 individual control element
31 individual control element
32 individual control element
33 individual control element
34 individual control element
35 individual drive assembly
36 individual drive assembly
37 individual drive assembly
38 individual drive assembly
39 individual drive assembly
40 individual drive assembly
41 individual drive assembly
42 individual drive assembly
43 individual drive assembly
45 surface
47 switch element
50 switching device
52 connector
54 connector

1. A control element, comprising a magnetorheological material and at least one drive assembly for generating a variable magnetic field.

2. The control element according to claim 1, wherein the magnetorheological material is in the form of a magnetorheological elastomer.

3. The control element according to claim 1, wherein the magnetorheological material is in the form of a magnetorheological fluid.

4. The control element according to claim 1, wherein the drive assembly comprises a coil for generating a magnetic field that at least partially surrounds the magnetorheological material.

5. The control element according to claim 1, configured to generate a variable feel for a user.

6. The control element according to claim 1, wherein the drive assembly is configured to vary the stiffness of the control element.

7. The control element according to claim 1, wherein the drive assembly is configured to vary the shape of the control element.

8. The control element according to claim 1, wherein the drive assembly is configured to generate a vibration in the control element at least one of with different frequencies, with different lengths of time or with an intermittent output, that the user can feel.

9. The control element according to claim 1, wherein the drive assembly is configured to allow at least part of the operating element to at least one of protrude from a surface or retract into the surface when activated.

10. The control element according to claim 1 comprising a push key or button.

11. The control element according to claim 1, comprising numerous individual control elements, each of which has its own drive assembly.

12. The control element according to claim 1, further comprising:
a magnetorheological elastomer that is coupled to a coil for generating a variable magnetic field; and
an electric switching device coupled to the coil,
wherein the coil is connected to the drive assembly at least at one end via a connector that has an element that can be moved manually,
wherein the switching device is configured to monitor at least one of the magnetic field or the capacitance between the two connectors, in order to trigger a switching procedure when the element that can be moved manually is activated.

13. The control element according to claim 1, wherein the control element is produced with 3D printing.

14. A method comprising: communicating with a user using a control element according to claim 1 by providing a change in a feel of the control element to the user, wherein the communicating comprises at least one providing feedback regarding activation of the control element through a vibration, or to requesting an input from the user through a vibration.

15. A vehicle comprising the control element according to claim 1.

16. The control element according to claim 2, wherein the drive assembly comprises a coil for generating a magnetic field that at least partially surrounds the magnetorheological material.

17. The control element according to claim 3, wherein the drive assembly comprises a coil for generating a magnetic field that at least partially surrounds the magnetorheological material.

18. The control element according to claim 2, configured to generate a variable feel for a user.

19. The control element according to claim 2, wherein the drive assembly is configured to vary the stiffness of the control element.

20. The control element according to claim 2, wherein the drive assembly is configured to vary the shape of the control element.
